(19) United States
(12) Patent Application Publication
(10) Pub. No.: US 2006/0173750 A1
(43) Pub. Date: Aug. 3, 2006

(54) System and method for controlling access to a local inventory storage system via a remote e-commerce application

(76) Inventors: Martin R. Naley, Encinitas, CA (US); Brian Mahoney, Buffalo, NY (US)

Correspondence Address: INGRASSIA FISHER & LORENZ, P.C., 7150 E. CAMELBACK, STE. 325, SCOTTSDALE, AZ, 85251, US

(21) Appl. No.: 11/322,748

(22) Filed: Dec. 30, 2005

Related U.S. Application Data
(60) Provisional application No. 60/640,310, filed on Dec. 30, 2004.

(51) Int. Cl. G06Q 30/00

(52) U.S. Cl. 705/26

(57) ABSTRACT

A local inventory control system according to the invention can be remotely regulated by a centralized server architecture. The local inventory control system contains product offered by a business entity, and the same business entity can control unlocking of the local inventory control system using the centralized server architecture. In a practical implementation, the inventory control features are integrated with e-commerce features such that the local inventory control system can be automatically unlocked subsequent to the completion of online purchase transactions initiated at the local site. The inventory control system is well-suited as part of a supply program to manage vendor inventories of life science research products.

### CROSS-REFERENCE TO RELATED APPLICATION

This application claims the benefit of U.S. provisional patent application Ser. No. 60/640,310, filed Dec. 30, 2004 (the entire content of which is incorporated by reference herein).

### TECHNICAL FIELD

The present invention relates generally to product storage and inventory control systems. More particularly, the present invention relates to a local product storage system having locking inventory control compartments that are controlled via an e-commerce application.

### BACKGROUND

A business entity, such as a manufacturer, distributor, supplier, or vendor of life sciences research products and services (such as Invitrogen Corporation), may operate supply programs, vendor managed inventories, and/or product storage systems at customer facilities, campuses, or sites. Traditionally, a supply program or a local product storage system allows the business entity to maintain product inventory at the customer site such that the product inventory is readily available to personnel at the customer site. The actual inventory maintained by the supply program may represent product that has already been purchased by the customer, where subsequent product orders are treated as replenishment orders. Alternatively, the actual inventory maintained by the supply program may represent “consignment” product for which the manufacturer is still responsible. Regardless of the actual inventory and purchase model, supply programs eliminate time delays that are normally associated with product shipping, eliminate time delays that are normally associated with unpacking of shipped product, and facilitate customized inventory stocking according to the specific customer needs. Manufacturers, distributors, or suppliers of life sciences research products, such as Invitrogen Corporation, may operate supply programs at medical or research facilities such as universities, government agencies, hospitals, or the like.

Controlling access to product inventory stored by a supply program or in a local product storage system can be important to both the manufacturer and the customer to prevent shrinkage, misuse of product, and for purposes of satisfying certain regulatory, administrative, or ethical requirements that may be imposed on the manufacturer and/or the customer. Historically, however, supply programs and local product storage systems have operated on an honor system that relies on inventory tracking and security procedures at the customer site. The prior art contains some locking freezers or local storage systems that utilize an electronic locking scheme that requires the manual entry of access codes or passwords via a keypad or other user interface incorporated into the storage system. The prior art also includes a local product storage system (e.g., a freezer) that is directly and locally coupled to a computer via a physical cable connection. The product storage system includes a locking door that is controlled by the local computer. These secure storage systems, however, are “self-contained” systems that are not controlled remotely by a third party such as the manufacturer or supplier of the product stored therein. Furthermore, these storage systems are not Internet-enabled, which may be desirable in some practical deployments.

Accordingly, it is desirable to have a local inventory control system that includes an electronic locking mechanism that can be remotely controlled via a remote central server system. In addition, it is desirable to have a local inventory control system that is Internet-enabled to facilitate easy migration with e-commerce transactions processed by the operator of the local inventory control system. Furthermore, other desirable features and characteristics of the present invention will become apparent from the subsequent detailed description and the appended claims, taken in conjunction with the accompanying drawings and the foregoing technical field and background.

### BRIEF SUMMARY

A local inventory control system according to the invention is suitably configured to securely store product inventory at a local site, where access to the product is remotely controlled by one or more server-based applications maintained by the business entity that provides the product. In illustrative embodiments, the product is a life sciences research product. In one practical embodiment, the local inventory control system is deployed in connection with an e-commerce site maintained by the business entity such that the business entity can remotely initiate an unlocking procedure in response to e-commerce transactions for product stored in the inventory control system.

The above and other aspects of the invention may be carried out in one form by a method for controlling access to product inventory. The method involves maintaining an inventory control application configured to regulate physical access to product stored in an inventory control system, processing an e-commerce transaction for purchased product stored in the inventory control system, generating, with the inventory control application, a business entity transaction code and a corresponding user transaction code, and comparing a code entered by a user to the business entity transaction code.

The above and other aspects of the invention may also be carried out in one form by an inventory control system having a locking compartment configured to securely store product, a communication module configured to receive unlock signals, via a data communication network, from a remote inventory control application configured to regulate physical access to product stored in the locking compartment, and a locking mechanism coupled to the locking compartment and coupled to the communication module, the locking mechanism being configured to unlock the locking compartment in response to an unlock signal received by the communication module.

The above and other aspects of the invention may also be carried out in one form by a remote server-based inventory control system having an e-commerce application that facilitates online purchases of product stored in a local inventory control system, an inventory control application configured to regulate physical access to product stored in the local inventory control system, where the e-commerce application processes a transaction for purchased product stored in the local inventory control system, and where the inventory control application electronically initiates unlocking of at least a portion of the local inventory control system to enable access to the purchased product.

The methods and inventory control system of the present invention are well-suited as part of a supply program to manage vendor inventories of life science research products.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of an example environment in which an inventory control architecture may be deployed;

FIG. 2 is a schematic representation of an inventory control architecture configured in accordance with an example embodiment of the invention;

FIG. 3 is a schematic representation of an inventory control system configured in accordance with an example embodiment of the invention;

FIG. 4 is a block diagram of an inventory control system configured in accordance with an example embodiment of the invention;

FIG. 5 is a block diagram of an inventory control server system configured in accordance with an example embodiment of the invention;

FIGS. 6 and 7 depict a flow chart of an internet-based inventory control process according to an example embodiment of the invention;

FIG. 8 depicts an alternate section of the internet-based inventory control process shown in FIGS. 6 and 7; and

FIG. 9 depicts another alternate section of the internet-based inventory control process shown in FIGS. 6 and 7.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, computer hardware, e.g., personal computers, server systems, network architectures, or the like, and physical storage devices, e.g., freezers, refrigerators, lockers, or the like, which may carry out a variety of functions under the control of one or more microprocessors or other control devices. In addition, those skilled in the art will appreciate that the present invention may be practiced in conjunction with any number of data transmission protocols and computer architectures, and that the system described herein is merely one exemplary application for the invention.

For the sake of brevity, conventional techniques related to e-commerce applications, email systems, Internet data communication protocols and technologies, signaling, network control, electromagnetic locking devices, electromagnetic actuators, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to components or features being “connected” or “coupled” together. As used herein, unless expressly stated otherwise, “connected” means that one component/feature is directly or indirectly connected to another component/feature, and not necessarily mechanically. Likewise, unless expressly stated otherwise, “coupled” means that one component/feature is directly or indirectly coupled to another component/feature, and not necessarily mechanically. Thus, although the various schematic diagrams shown herein may depict example arrangements of elements, additional intervening elements, devices, features, or components may be present in an actual embodiment (assuming that the functionality of the overall system is not adversely affected).

An inventory control architecture according to the invention can be deployed in the context of an e-commerce system maintained by a business entity that offers goods and/or services via online purchasing. Although certainly not limited to any particular type of product, the inventory control architecture is suitable for use in connection with the online offering of life sciences research products, which may include, without limitation: antibodies; clone collections; cloning tools and technologies; electrophoresis products, such as gels; enzymes; laboratory services; gene expression analysis tools and technologies; genome analysis tools and technologies; bioinformatics software; drug discovery tools and technologies; molecular probes; PCR and RT-PCR tools and technologies; protein interaction products; purification products; RNAi products; sequencing products; transfection and molecular transfer products, such as reagents; transformation products; reagents; proteomics tools and technologies; cell culture products; and primers. These and other life sciences research products are available from Invitrogen Corporation.

As used herein, the term “provider” refers to any individual, institution, corporation, university, business entity, or organization seeking to provide products and/or services, such as life sciences research products and/or services. A provider can be, for example, a manufacturer, retailer, vendor, distributor, or reseller.

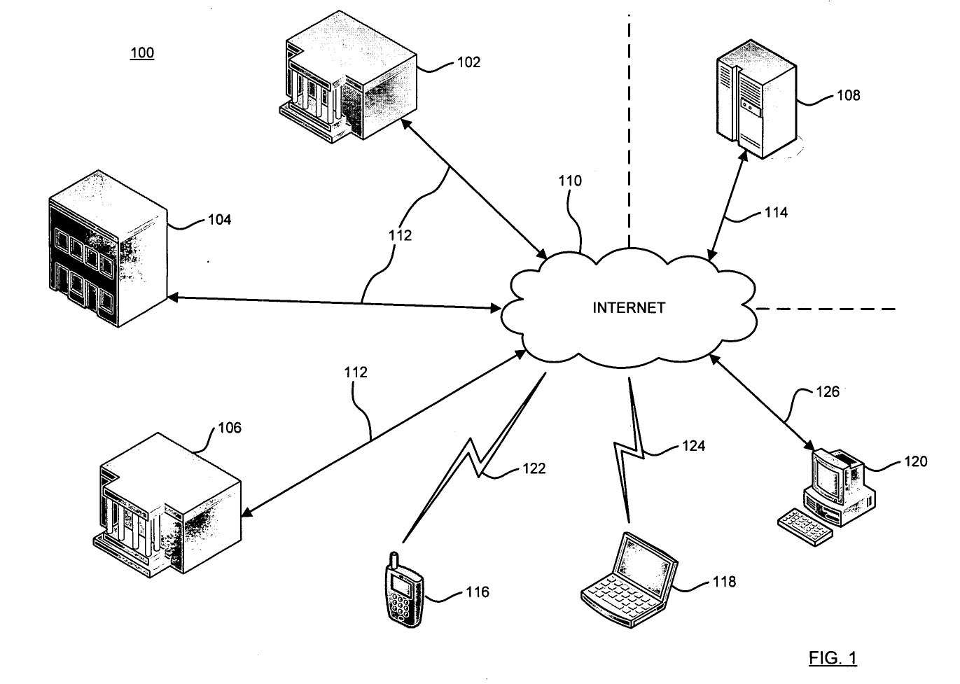

FIG. 1 is a schematic representation of an example environment 100 in which an inventory control architecture may be deployed. In the context of environment 100, a business entity (e.g., a manufacturer, vendor, distributor, provider, or reseller of product, or an entity that provides online services on behalf of a manufacturer, vendor, distributor, provider, or reseller of product) may support e-commerce transactions for products offered by a local supply program operated or maintained by the business entity, and/or for products located at a product storage facility or an inventory control system operated or maintained by the business entity. As used herein, an e-commerce transaction represents an online purchase of product, initiated by a user/purchaser, such as a customer or a customer entity. The prior art is replete with technologies and methodologies related to the handling, processing, and management of e-commerce transactions, and such known technologies and methodologies can be leveraged in connection with an e-commerce enabled supply program.

Environment 100 may include any number of customer buildings, facilities, structures, sites, campuses, or locations (identified by reference numbers 102, 104, and 106). Although locations 102/104/106 may be affiliated with any number of different customer entities, the following description assumes that locations 102/104/106 are affiliated with a single customer entity, such as a university or a government research facility. One or more of locations 102/104/106 may include one or more supply programs and/or one or more local inventory control systems for products offered by the business entity. In practice, a supply program may include, support, or maintain any number of local inventory control systems as described herein.

In accordance with the example embodiment of the invention, the local inventory control systems are controlled by a remote server architecture 108 operated by the business entity. In the practical deployment, the local inventory control systems communicate with remote server architecture 108 via a suitable data communication network such as the Internet 110. Thus, each location 102/104/106 may support bi-directional data communication with the Internet 110 via any number of respective links 112, and remote server architecture 108 may support bi-directional data communication with the Internet 110 via one or more links 114. The dashed lines in FIG. 1 are intended to represent the physical and operational separation between remote server architecture 108 and locations 102/104/106.

As described in more detail below, remote server architecture 108 may be realized with any number of hardware devices, systems, or components. Briefly, remote server architecture 108 is suitably configured to support a number of e-commerce and inventory control functions, features, and operations. In connection with the processing of e-commerce transactions, remote server architecture 108 may generate e-commerce web pages for display at customer computing devices. As used herein, a “customer computing device” may be any device or system configured to support e-commerce transactions in accordance with known technologies and methodologies. For example, a customer computing device may be an Internet-enabled handheld device 116 (such as a PDA, a cellular telephone, a paging device, a palmtop computer, or the like), a laptop computer 118, a desktop computer 120, or the like. As depicted in FIG. 1, handheld device 116 may communicate with the Internet 110 via a wireless link 122, laptop computer 118 may communicate with the Internet 110 via a link 124 (which may be wired or wireless), and desktop computer 120 may communicate with the Internet 110 via a link 126. Notably, these customer computing devices may be located anywhere in environment 100. For example, a customer computing device may be: located at any of locations 102/104/106; incorporated into a supply program or a local inventory control system; or incorporated into a publicly accessible machine (akin to an automated banking machine). Of course, a vast number of alternative arrangements are possible within environment 100, and these specific examples are not intended to limit the application of the invention in any way.

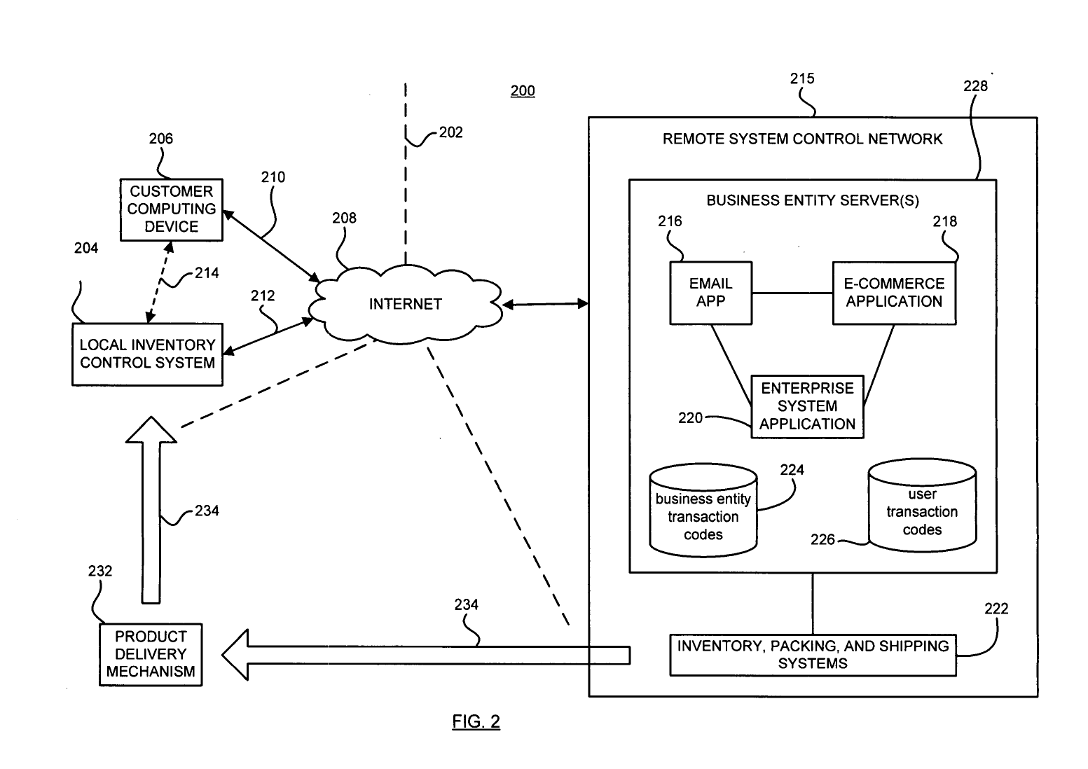

FIG. 2 is a schematic representation of an inventory control architecture 200 configured in accordance with an example embodiment of the invention. In the preferred embodiment, inventory control architecture 200 is deployed in the context of an online e-commerce system, where any number of remote users can purchase products via a web site maintained by a business entity. In this regard, FIG. 2 depicts an imaginary line 202 that generally divides inventory control architecture 200 into three sections. The section to the right of FIG. 2 includes physical and logical components or features that are maintained, owned, controlled, and/or operated by the business entity, while the section to the left of FIG. 2 represents physical and logical components or features corresponding to a customer site, location, or facility. The section near the lower left corner of FIG. 2 represents a “transit space” having physical and logical components or features that may be maintained, owned, controlled, and/or operated by one or more third parties, e.g., shipping entities. Although the inventory control scheme described herein can support any number of local inventory control systems and any number of customer computing devices, inventory control architecture 200 represents a simple example that includes one local inventory control system 204 and one customer computing device 206.

Inventory control architecture 200 generally includes at least one customer computing device 206 (such as a personal computer or any of the devices described above in connection with FIG. 1), each of which is connected to a data communication network (such as the Internet 208 in this example) to facilitate online transactions as described herein. Bi-directional network traffic between customer computing device 206 and the Internet 208 may be carried over one or more links 210. As mentioned above, customer computing device 206 may be located at or be otherwise associated with a customer site or location. In this example, local inventory control system 204 is also located at the same customer site or location. In accordance with one practical embodiment, local inventory control system 204 includes a climate controlled product storage device, such as a freezer, a refrigerator, or a cooler, having one or more temperature controlled compartments that provide a suitable storage environment for life sciences research products. In accordance with the preferred embodiment of the invention, local inventory control system 204 is also connected to a data communication network (such as the Internet 208) to facilitate network control and monitoring by a centralized server architecture maintained by the business entity. In this regard, local inventory control system 204 may be considered to be “Internet-enabled” and may support bi-directional network traffic with the Internet 208 via one or more links 212. In practice, local inventory control system 204 may be configured as a network component having an IP address or other identifier for compatibility with known Internet data communication protocols, technologies, and techniques. It should be appreciated that customer computing device 206 may be incorporated into, or connected to, local inventory control system 204, as represented by the dashed arrow 214 in FIG. 2. Furthermore, local inventory control system 204 may include one or more additional devices or subsystems, which may be integrated with or coupled to the actual product storage device. For example, local inventory control system 204 may be connected to a computing system, such as a personal computer, that serves as the communication device or module for Internet traffic. In addition, local inventory control system 204 may include a control signal converter or “smart transceiver” that functions as an interface for the product storage device.

Those skilled in the art are aware that the Internet 208 may be considered to be a packet network in that data packets are routed throughout the Internet 208 to facilitate data communication between an originating device and a destination device. In this regard, inventory control architecture 200 may utilize one or more data communication protocols that are compatible with Internet or other computer network architectures. For example, inventory control architecture 200 may utilize any number of the following technologies, protocols, or features (without limitation) in connection with its data communication operations: TCP/IP; WAP; IEEE 802.11 (any variation thereof); Bluetooth; Ethernet; IEEE 1394 (Firewire); GPRS; USB; IEEE 802.15.4 (ZigBee); or IrDA (infrared).

Inventory control architecture 200 may also include a number of business entity components that may be deployed in the context of a remote system control network 215. These business entity components may include, without limitation: an email application 216; an e-commerce application 218; an enterprise system application 220; and various inventory, packing, and shipping systems 222, which may include any number of additional servers, computer devices, or related equipment. For ease in description, email application 216, e-commerce application 218, and enterprise system application 220 are depicted as separate applications. In practice, however, one or more of these applications (and possibly other applications maintained by remote system control network 215) may be combined into a single logical element or application, any number of these applications (and possibly other applications maintained by remote system control network 215) may reside in a single server hardware device. In this example, email application 216, e-commerce application 218, and enterprise system application 220 are each connected to the Internet 208, via remote system control network 215, to facilitate bi-directional communication with local inventory control system 204, customer computing device 206, and/or each other. Therefore, email application 216, e-commerce application 218, and enterprise system application 220 are each coupled (directly, indirectly, using wired links, and/or using wireless links), via the Internet 208, to customer computing device 206 and to local inventory control system 204. Inventory control architecture 200 may further include a number of business entity databases or memory elements, including, without limitation: a business entity transaction code storage element 224 and a user transaction code storage element 226. These codes and their significance are described in more detail below. In practice, each storage element 224/226 may be coupled to or integrated with e-commerce application 218, enterprise system application 220, or any suitable application residing in remote system control network 215. Furthermore, it should be appreciated that a practical system may employ a different database and server architecture than that shown in FIG. 2. For example, inventory control architecture 200 may employ any number of business entity servers 228 to support email application 216, e-commerce application 218, and enterprise system application 220, and a single piece of centralized server equipment may be preferred in certain practical embodiments.

In FIGS. 1 and 2, the various customer computing devices, remote server architecture 108, email application 216, e-commerce application 218, enterprise system application 220, and possibly certain aspects of inventory, packing, and shipping systems 222 represent physical hardware components, virtual machines, or logical components. Any given server may be realized as a computing device or a computer system configured to perform the respective server application tasks described herein (and possibly other tasks), while the customer computing devices may be suitably configured to perform tasks associated with conventional end user applications, such as web browser applications. In a practical deployment, the business entity components may communicate with one another via a suitably configured network architecture.

A “server” is often defined as a computing device or system configured to perform any number of functions and operations associated with the management, processing, storage, retrieval, and/or delivery of data, particularly in a network environment. Alternatively, a “server” or “server application” may refer to software that performs such processes, methods, and/or techniques. In practical applications, a server component that supports inventory control architecture 200 may be configured in accordance with any known computer platform, e.g., Compaq Alpha Tru64, FreeBSD, HP-UX, IBM AIX, Linux, NCR MP-RAS, SCO OpenServer, SCO Unixware, SGI Irix, Solaris (Sparc), Solaris (Intel), Windows 2000, Windows NT, or Novell Netware. As in most commercially available general purpose servers, a practical server component that supports inventory control architecture 200 may be configured to run on any suitable operating system such as Unix, Linux, the Apple Macintosh OS, or any variant of Microsoft Windows, and it may employ any number of microprocessor devices, e.g., the Pentium family of processors by Intel or the processor devices commercially available from Advanced Micro Devices, IBM, Sun Microsystems, or Motorola.

With regard to the customer computer devices and the various servers described herein, the respective processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, the operating system programs and the server application programs reside in the permanent memory and portions thereof may be loaded into the system memory during operation. In accordance with the practices of persons skilled in the art of computer programming, the present invention is described herein with reference to symbolic representations of operations that may be performed by the various server components or the client components. Such operations are sometimes referred to as being computer-executed, computerized, software-implemented, or computer-implemented. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention (which may reside at the customer computing devices, or at one or more of the business entity components, particularly the servers) are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

E-commerce application 218 represents one of the main processing engines for inventory control architecture 200. Generally, e-commerce application 218 is configured to generate web pages to facilitate online purchases of products stored in local inventory control system 204. E-commerce application 218 is suitably configured to generate an e-commerce web site for the business entity, where the e-commerce web site may include any number of web pages designed to support traditional e-commerce functionality and to otherwise facilitate the processing of online transactions for purchased product stored in local inventory control system 204. In this regard, e-commerce application 218 may generate and transmit web pages, via the Internet 208, to conventional web browser applications running on customer computing device 206. These web pages preferably enable an online customer to browse an appropriate online product catalog of the business entity, create an online account profile, select products for purchase, complete online purchase transactions, view order history, and perform other tasks normally associated with online e-commerce applications. In addition, e-commerce application 218 may be configured to specify appropriate stock and inventory levels and to calculate replenishments amounts, which can then be communicated to enterprise system application 220 for appropriate handling.

Enterprise system application 220 may be suitably configured to perform a number of functions in support of inventory control architecture 200 and e-commerce application 218. For example, enterprise system application 220 may perform or facilitate any of the following functions, without limitation: order processing; accounting; dispatching of shipments; invoicing; and maintaining inventory records. In this regard, enterprise system application 220 may communicate with one or more of the inventory, packing, and shipping systems 222 to monitor, control, or initiate the updating of inventory databases, the packing of purchased product, and the shipping of purchased product to the intended recipients.

Business entity server(s) 228 may also maintain a remote inventory control application, which is suitably configured to perform a number of functions in support of inventory control architecture 200. The remote inventory control application is not separately shown in FIG. 2 because it may be incorporated into e-commerce application 218, enterprise system application 220, and/or other server-based applications maintained by the business entity. The remote inventory control application is generally configured to regulate physical access to product stored in local inventory control system 204 using the techniques described below. In particular, the remote inventory control application is preferably configured to control or initiate control of a physical locking mechanism of local inventory control system 204. Furthermore, the remote inventory control application may communicate with one or more of the inventory, packing, and shipping systems 222 to monitor, control, or initiate the updating of inventory databases, the packing of replenish product, and the shipping of replenish product for restocking in local inventory control system 204. FIG. 2 depicts a product delivery mechanism 232 that can be employed to transfer replenish product from the custody of the business entity to the customer via a suitable shipping route 234.

Email application 216 may operate in a conventional manner to receive, transmit, and process email for use in connection with e-commerce application 218 and/or to otherwise support inventory control architecture 200. For example, email application 216 may be employed to send purchase confirmation emails to customers, to receive inquiries from customers, or to send user transaction codes to user/purchasers in response to the completion of certain e-commerce transactions. Thus, email application 216 may be coupled to e-commerce application 218 and to the Internet 208 to facilitate email transmission with online customers. It should be appreciated that the operating details of email systems are known to those skilled in the art and, therefore, will not be addressed herein.

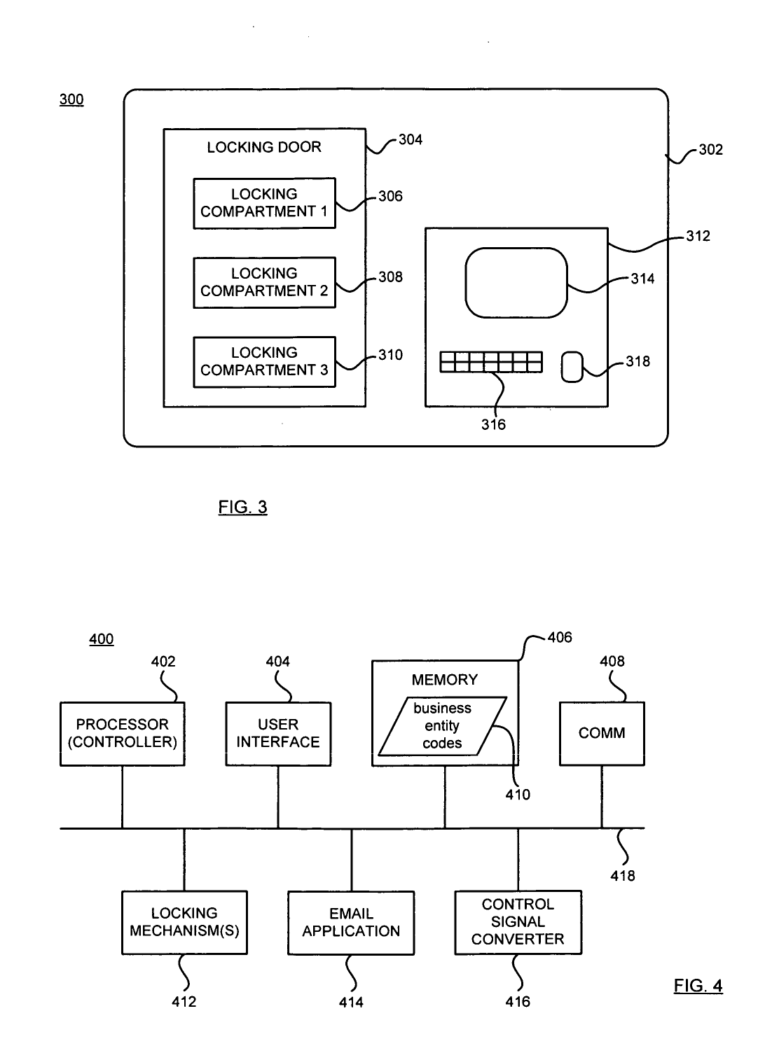

FIG. 3 is a schematic representation of a local inventory control system 300 (which may also be referred to as a supply program or a supply center) configured in accordance with an exemplary embodiment of the invention. System 300 is one suitable example of local inventory control system 204 shown in FIG. 2. In one practical embodiment, local inventory control system 300 includes a physical structure for storing products, such as life sciences research reagents. The physical structure, or portions thereof, can be held at any temperature used for storing life sciences research reagents, such as, but not limited to: −70° C.; 0° C.; 4° C.; 20° C.; 25° C.; 27° C.; 28° C.; 30° C.; 37° C.; or ambient room temperature. In this regard, local inventory control system 300 (or a portion thereof) may be realized as a refrigerator or a freezer. The primary physical structure of local inventory control system 300 typically includes an enclosure and a door for gaining access to the life sciences research products stored within the enclosure.

Local inventory control system 300 may include an outer cabinet or housing 302, a locking door 304 that may serve as a primary means of security for product stored in housing 302, a first locking compartment 306, a second locking compartment 308, a third locking compartment 310, and a user interface 312. Each locking compartment represents a secondary means for securely storing product contained in local inventory control system 300. In this regard, each locking compartment may represent a storage location for a specific product having a particular SKU, or a category of product. A practical embodiment may include any number of locking doors and any number of locking compartments. For example, a simple embodiment may resemble a freezer having only one locking door and no individually locking compartments. Another example embodiment may have small separate locking compartments with no locking door. Depending upon the practical embodiment, local inventory control system 300 may include any number of locking mechanisms (not shown in FIG. 3) for locking door 304 and locking compartments 306/308/310. For example, local inventory control system 300 may include individually controlled locking mechanisms for each lockable element. Alternatively, local inventory control system 300 may utilize one locking mechanism to control access to a plurality of lockable elements. Furthermore, a practical locking mechanism may be realized as a single piece of hardware or a subsystem that is capable of controlling access to a plurality of lockable elements in an individual manner.

As mentioned above, local inventory control system 300 may include or be locally coupled to user interface 312. In this example, FIG. 3 depicts user interface 312 being integrated with local inventory control system 300. User interface 312 is preferably configured to allow the user/purchaser to enter data into local inventory control system 300 and/or to view or otherwise obtain information from local inventory control system 300. For example, user interface 312 may enable the user/purchaser to perform e-commerce transactions with e-commerce server 218 (see FIG. 2) for product stored in local inventory control system 300. In accordance with one practical embodiment of the invention, user interface 312 is configured to accept data from a user/purchaser, such as a password or an user transaction code, that controls the unlocking of locking door 304 and/or locking compartments 306/308/310.

In the example embodiment, user interface 312 includes a display element 314 and one or more data entry components, such as a keyboard or keypad 316 and a cursor control device 318. The specific configuration, operating characteristics, and functionality of display element 314, keypad 316, and cursor control device 318 can vary depending upon the practical implementation of local inventory control system 300. For example, display element 314 may be a CRT, LCD, or plasma monitor, keypad 316 may be a standard sized personal computer keyboard, a small-scale keypad, a touch screen, or a stylus writing screen, and cursor control device 318 may be a mouse, a touchpad, a trackball, a stylus writing screen, or a joystick. User interface 312 may also include a speaker system, a microphone system, a camera system, or the like (not shown).

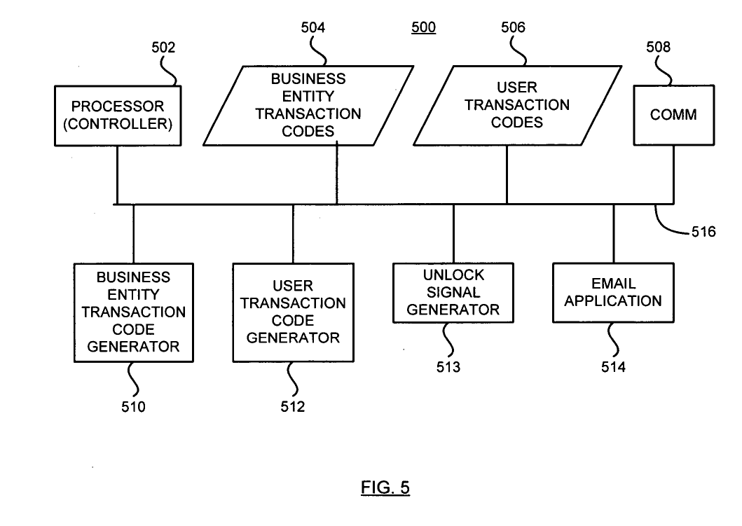

FIG. 4 is a block diagram of a local inventory control system 400 configured in accordance with an example embodiment of the invention. System 400 may be implemented in the context of local inventory control system 300 shown in FIG. 3, or in the context of local inventory control system 204 shown in FIG. 2. Although not shown in FIG. 4, a practical local inventory control system 400 can include a number of functional elements, logical elements, and/or hardware components that support system features and functions unrelated to the invention. Local inventory control system 400 generally includes a processor (or controller) 402, a user interface 404 (which may be configured as described above in connection with user interface 312), a suitable amount of memory 406, a data communication module 408, business entity transaction code data 410 (which may be received by data communication module 408 and stored in memory 406), one or more locking mechanisms 412, an email application 414, and a control signal converter 416. Local inventory control system 400 may include a data bus 418 (or any suitable interconnecting element, system, or arrangement) to facilitate communication of data or control signals between some or all of the above components.

Processor 402 may be any general purpose microprocessor, controller, or microcontroller that is suitably configured to control the operation of local inventory control system 400, or at least govern the processes described herein. Memory 406 may be realized as any processor-readable medium, including an electronic circuit, a semiconductor memory device, a ROM, a flash memory, an erasable ROM, a floppy diskette, a CD-ROM, an optical disk, a hard disk, an organic memory element, or the like. As described in more detail below, in one practical embodiment, memory 406 is capable of storing business entity transaction code data 410 received from remote system control network 215 via the Internet 208 (see FIG. 2).

Communication module 408 is configured to facilitate bi-directional data communication between local inventory control system 400 and a data communication network such as the Internet 208. In an alternate embodiment, the communication module is realized in a computing device that is physically distinct from the product storage subsystem of the local inventory control system, and that computing device functions as a communication subsystem for the product storage subsystem. In one example embodiment, communication module 408 is suitably configured to receive business entity transaction code data 410 generated by the server-based remote inventory control application subsequent to an online e-commerce transaction for product stored in local inventory control system 400, where such business entity transaction code data 410 corresponds to at least one locking mechanism 412 of local inventory control system 400. In another example embodiment, communication module 408 is suitably configured to receive an unlock signal generated by the remote inventory control application in response to an online e-commerce transaction for product stored in local inventory control system 400, where the unlock signal controls (or otherwise initiates) unlocking of at least one locking mechanism 412 of local inventory control system 400. In the example embodiment, communication module 408 communicates with the respective business entity components, via the Internet 208, in accordance with known data communication protocols and techniques, and communication module 408 may be realized with hardware, software, and/or firmware using known techniques and technologies. In this regard, communication module 408 is preferably IP-enabled to facilitate Internet-based data communication.

In practical embodiments of the invention, locking mechanism 412 may include a physical locking element that is controlled with a suitably configured actuator control signal. Locking mechanism 412 may utilize any number of known lock technologies, including, without limitation: deadbolts; magnetic fields; pin tumblers; and latches. In one preferred embodiment of the invention, the actuator control signal is an electromagnetic signal generated by local inventory control system 400 following the completion of an online e-commerce transaction for product stored in local inventory control system 400. For example, the actuator control signal may be generated by local inventory control system 400 in response to an IP-based control signal generated by business entity server(s) 228 upon completion of an e-commerce transaction for stored product. Control signal converter 416 functions to convert the IP-based control signal, which may be received by communication module 408, into the actuator control signal. As another example, the actuator control signal may be generated by local inventory control system 400 in response to the local entry of a correct password or user transaction code by a user of local inventory control system 400. In such an embodiment, control signal converter 416 may simply convert an internally generated control signal into the actuator control signal. The specific operating details of control signal converter 416 may vary from one system to another, depending upon the type of locking mechanism(s) 412 utilized by local inventory control system 400.

Email application 414 may be deployed in some embodiments of local inventory control system 400 to facilitate email communication with email application 216 (and/or other business entity components). Email application 414 may operate in a conventional manner to receive, transmit, and process email for use in connection with local inventory control system 400, e-commerce transactions initiated at local inventory control system 400, and/or to otherwise support inventory control architecture 200. For example, email application 414 may be employed to receive business entity transaction codes generated by business entity server(s) 228 in response to the completion of certain e-commerce transactions. Notably, email application 414 need not be accessible to the user/purchaser, and it may be realized as an embedded application for local inventory control system 400. It should be appreciated that the operating details of email applications are known to those skilled in the art and, therefore, will not be addressed herein.

A local inventory control system may also be configured to communicate information, e.g., inventory related data, to remote system control network 215. For example, the local inventory control system and/or individual locking components (bins, compartments, shelves, or the like) may be suitably configured to function as an intelligent sender of information. In this regard, the local inventory control system may include or communicate with sensors, detectors, measurement devices, and processing logic configured to perform one or more of the following functions: (1) send device hardware information such as storage temperatures, power quality measurement data, door/compartment status (closed, open, unlocked, locked) data, or access history information; (2) send product inventory information (such as SKUs) related to individual products, where such information may include current quantity, product “shelf” history, and stock movement history; (3) upload the locally obtained information to remote system control network 215 for potential use by the business entity, the user/purchaser, or other devices in the remote inventory control architecture. Regarding item (2), the product information may be collected using RFID tag and reader technology or other inventory control techniques. Regarding item (3), time sensitive information may result in the automatic generation of notifications for the user/purchaser or the responsible sales representative. In summary, the deployment of an intelligent local inventory control system may be desirable to provide real-time inventory data to the user/purchaser, the customer entity, the business entity, and/or sales representatives for the business entity. In addition, an intelligent local inventory control system could provide valuable information to manage product recalls or to manage product having expiration dates.

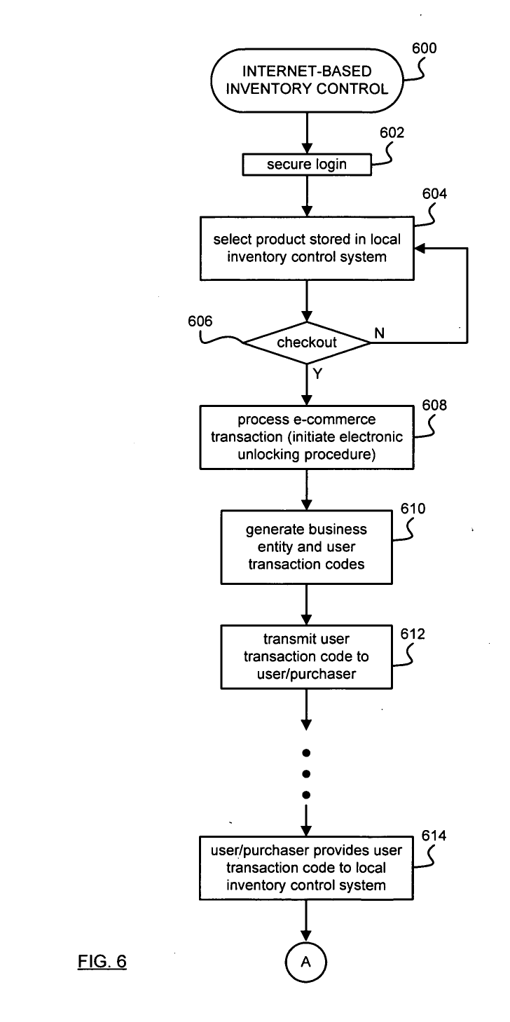

FIG. 5 is a block diagram of a business entity server system 500 configured in accordance with an example embodiment of the invention. Server system 500 is one suitable example of business entity server 228 shown in FIG. 2. Although not shown in FIG. 5, a practical business entity server system 500 can include a number of functional elements, logical elements, and/or hardware components that support system features and functions unrelated to the invention. Business entity server system 500 generally includes a processor (or controller) 502, a business entity transaction code database or storage element 504 (which may be, for example, storage element 224), a user transaction code database or storage element 506 (which may be, for example, storage element 226), a data communication module 508, a user transaction code generator 510, a business entity transaction code generator 512, an unlock signal generator 513, and an email application 514 (which may be, for example, email application 216). Business entity server system 500 may include a data bus 516 (or any suitable interconnecting element, system, or arrangement) to facilitate communication of data or control signals between some or all of the above components.

Processor 502 may be any general purpose microprocessor, controller, or microcontroller that is suitably configured to control the operation of business entity server system 500, or at least govern the processes described herein. Storage elements 504/506 may each be realized in connection with any processor-readable medium, including an electronic circuit, a semiconductor memory device, a ROM, a flash memory, an erasable ROM, a floppy diskette, a CD-ROM, an optical disk, a hard disk, an organic memory element, or the like. In this regard, storage elements 504/506 may utilize any number of known database technologies, including database management applications. As described in more detail below, storage element 504 is suitably configured to store business entity transaction codes generated by the server-based remote inventory control application, and storage element 506 is suitably configured to store user transaction codes generated by the server-based remote inventory control application.

Communication module 508 is configured to facilitate bi-directional data communication between business entity server system 500 and a data communication network such as the Internet 208. In one example embodiment, communication module 508 is suitably configured to transmit business entity transaction code data 504 to the local inventory control systems, and to transmit user transaction code data 506 to users/purchasers in response to an online e-commerce transaction for product stored in the respective local inventory control systems. In this embodiment, a user transaction code that matches or otherwise corresponds to a business entity transaction code maintained at a local inventory control system or maintained at business entity server 500 will initiate unlocking of at least one locking component of the local inventory control system. In another example embodiment, communication module 508 is suitably configured to transmit an unlock signal generated by business entity server system 500 in response to an online e-commerce transaction for product stored in a local inventory control system, where the unlock signal controls (or otherwise initiates) unlocking of at least one locking mechanism of that local inventory control system. In the example embodiment, communication module 508 communicates with the respective local customer components, via the Internet 208, in accordance with known data communication protocols and techniques, and communication module 508 may be realized with hardware, software, and/or firmware using known techniques and technologies. In this regard, communication module 508 is preferably IP-enabled to facilitate Internet-based data communication.

User transaction code generator 510 is suitably configured to generate user transaction codes, and business entity transaction code generator 512 is suitably configured to generate business entity transaction codes, as needed to support the operation of the inventory control architecture. As mentioned previously, user transaction code generator 510 and business entity transaction code generator 512 are responsive to e-commerce transactions for purchased product stored in locking compartments of local inventory control systems. As used herein, a business entity transaction code represents a code that may be sent to a specified local inventory control system for storage therein or a code that may be generated and stored by business entity server system 500, while a user transaction code represents a corresponding code that is sent to a user/purchaser to enable unlocking of a locking component of the specified local inventory control system. In practice, the codes are realized as digital representations of alphanumeric characters. In a simple implementation of the invention, the user transaction code is identical to the corresponding business entity transaction code, and the codes can be generated using a random number generator, a sequential number generator, or the like. In other implementations of the invention, the user transaction code may represent a key or a seed value for calculating or otherwise deriving the matching business entity transaction code. For example, known encryption or cryptographic techniques may be employed in this context.

Unlock signal generator 513 is suitably configured to generate unlock signals as needed to support the operation of the inventory control architecture. Unlock signals may be employed in lieu of, or in addition to, the codes described above. Unlock signal generator 513 is preferably responsive to e-commerce transactions for purchased product stored in locking compartments of local inventory control systems. As used herein, an unlock signal represents a suitably formatted control signal or data item that can be transmitted from business entity server system 500, where the unlock signal is sent to a specified local inventory control system for local processing. As mentioned above, the receiving local inventory control system may then convert the unlock signal into an actuator control signal configured to operate one or more locking mechanisms at the specified local inventory control system. In accordance with one practical embodiment of the invention, the unlock signal is an IP-based signal containing one or more data packets suitable for transmission via the Internet.

Email application 514 may be deployed in some embodiments of business entity server system 500 to facilitate the generation of email messages. Email application 514 may operate in a conventional manner to receive, transmit, and process email for use in connection with business entity server system 500 and/or to otherwise support inventory control architecture 200. For example, email application 514 may be employed to generate email messages to users/purchasers in response to the completion of certain e-commerce transactions, where such email messages contain the user transaction codes required to gain physical access to product stored in the local inventory control systems. In addition, such email messages may contain instructions for the users/purchasers or other confirmation notifications. It should be appreciated that the operating details of email applications are known to those skilled in the art and, therefore, will not be addressed herein.

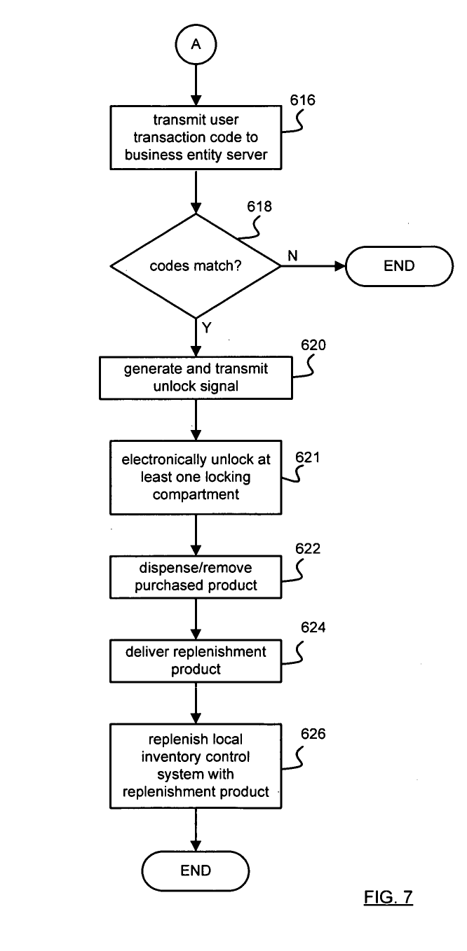

Generally, the various functional and logical elements depicted in FIGS. 1-5 are suitably configured to carry out the e-commerce and inventory control operations and techniques described herein. In this regard, FIGS. 6 and 7 depict a flow chart of an internet-based inventory control process 600 according to an example embodiment of the invention. Process 600 assumes that the business entity components and at least one local inventory control system as described above have already been deployed in a suitable operating environment. For convenience, process 600 outlines an example transaction between one user/customer and one local inventory control system. Of course, the invention is not limited to such an example, and a practical inventory control architecture leverages the centralized server-based nature of the business entity components, thus facilitating the control and management of a vast number of remotely located inventory control systems.

It should be appreciated that the various tasks performed in connection with internet-based inventory control process 600 may be performed by software, hardware, firmware, or any combination thereof. For illustrative purposes, the following description of process 600 may refer to elements mentioned above in connection with FIGS. 1-5. In practical embodiments, portions of process 600 may be performed by different elements of the described system, e.g., the local inventory control system or any of the business entity components, including, without limitation, the email application, the e-commerce application, or the remote inventory control application. It should also be appreciated that process 600 may include any number of additional or alternative tasks, the tasks shown in FIGS. 6 and 7 need not be performed in the illustrated order, and process 600 may be incorporated into a more comprehensive procedure or process having additional functionality not described in detail herein.

Inventory control process 600 may begin with a secure login procedure (task 602) that allows the user/purchaser to access e-commerce application 218 via an online account or profile. In a practical embodiment, e-commerce application 218 may generate a suitable web page that allows the user/purchaser to enter login data at customer computing device 206. Assuming that the login is successful, the user/purchaser may navigate or be directed to an e-commerce web site that offers product stored at local inventory control system 204. Thereafter, e-commerce application 218 may allow the user/purchaser to select product stored in local inventory control system 204 (task 604). In a practical deployment, a user/purchaser may have access to a plurality of local inventory systems, which may be physically dispersed throughout a localized region, e.g., in different buildings on a university campus, in different labs within a research facility, or the like. Furthermore, a user/purchaser may have access to any number of individually locked compartments or regions within a given local inventory control system. Indeed, a user/purchaser may have only limited access to a specified number of products, and the individual locking mechanisms described herein provide a convenient means for the customer entity and/or the business entity to control individualized access to certain products. Consequently, in connection with task 604, process 600 may prompt the user/purchaser to identify a specific local inventory control system and/or a specific bin, compartment, or product contained in the identified local inventory control system. Alternatively, process 600 may automatically identify the location of the selected products by suitable processing of their product catalog identifiers (e.g., SKUs), and/or provide a list of nearby locations for selection by the user/purchaser.

In accordance with conventional e-commerce methodologies, the user/purchaser can select products online and initiate an online checkout procedure to complete the transaction (task 606). In a practical embodiment of the invention, inventory control process 600 generates a suitable checkout web page to enable the user/purchaser to confirm the transaction. In response to such confirmation, e-commerce application 218 can process the e-commerce transaction in a suitable manner using known techniques (task 608). In addition, e-commerce application 218, enterprise system application 220, and/or the remote inventory control application may initiate the electronic unlocking of at least a portion of local inventory control system 204 to enable access to the purchased product, using the procedures described herein.

In accordance with one preferred embodiment of the invention, inventory control process 600 prompts remote inventory control application 230 to generate business entity transaction codes and corresponding user transaction codes (task 610) to enable access to the purchased products. Depending upon the number of products purchased, their physical location within local inventory control system 204, and whether they are dispersed among a plurality of local inventory control systems 204, task 610 may generate any number of code combinations (for simplicity, this example assumes that one business entity transaction code and one user transaction code are generated for purposes of unlocking only one locking compartment). The codes may be stored in storage elements 224/226 for subsequent use, for recordkeeping purposes, and/or for archival purposes. Once generated, the user transaction code is transmitted to the user/purchaser (task 612) using any suitable data communication methodology. In one preferred embodiment, the user transaction code is sent in an email addressed to the user/purchaser. Alternatively, the user transaction code may be conveyed via a confirmation web page generated by e-commerce application 218.

Local inventory control system 204 may be configured to maintain the purchased product in a locked state for an indefinite amount of time. In practice, as an added security measure the user transaction code may have a limited lifespan. Assuming that the user/purchaser has successfully received the user transaction code, he or she can then enter or otherwise provide the user transaction code to local inventory control system 204 (task 614). The ellipses in FIG. 6 represent a possible time delay between the time that the user transaction code are transmitted to the time that the user/purchaser actually decides to obtain the purchased product. In this regard, local inventory control system 204 can keep the product secured until the user/purchaser decides to pick up the product. Once local inventory control system 204 receives the user transaction code, it can then initiate the transmission of the user transaction code (or a signal that contains, defines, or indicates the user transaction code) from local inventory control system 204 to business entity server(s) 228 (task 616) to enable business entity server(s) 228 to process the received user transaction code to determine its validity. In practice, the remote inventory control application residing at business entity server(s) 228 may compare the received user transaction code to one or more stored business entity transaction codes (query task 618). Alternatively, the remote inventory control application may perform a decryption, decoding, or any suitable algorithm to process the received user transaction code and/or one or more stored business entity transaction codes. If the user transaction code does not match or otherwise correspond to one of the stored business entity transaction codes, then inventory control process 600 may end, generate an error message, or prompt the user/purchaser to enter a different user transaction code.

If, however, query task 618 determines that the entered user transaction code matches or otherwise corresponds to one of the stored business entity transaction codes, then inventory control process 600 may cause business entity server(s) 228 to generate a suitable unlock signal and transmit the unlock signal back to local inventory control system 204 (task 620). Once received by local inventory control system 204, the unlock signal initiates the electronic unlocking of at least one of the locking compartments, doors, or bins of local inventory control system 204 (task 621). As mentioned above, the unlock signal preferably causes local inventory control system 204 to generate a suitable actuator control signal for the identified locking components, to thereby unlock the purchased product. Once local inventory control system 204 is in an unlocked state, it may then dispense the purchased product and/or allow the user/purchaser to remove the purchased product (task 622). After the product is removed, local inventory control system 204 may then return to a locked state, thus re-securing the remaining product stored therein.

In connection with the completion of the e-commerce transaction for the purchased product and/or in response to the removal of the purchased product, the business entity components may initiate a product replenishment procedure to restock local inventory control system 204 (task 626). For example, inventory, packing, and shipping systems 222 may be utilized to initiate delivery of replenishment product to local inventory control system 204 as a replacement for the purchased product. Following task 626, inventory control process 600 may end.

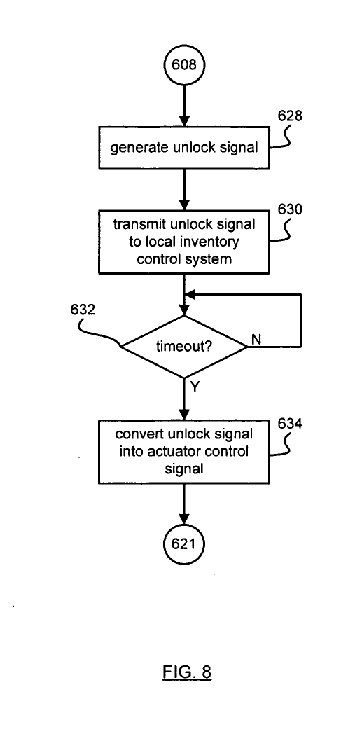

FIG. 8 depicts an alternate section of inventory control process 600, which may be employed by another practical embodiment of the invention. As depicted in FIG. 8, the alternate tasks may begin in response to the processing of the e-commerce transaction (task 608) and may end by initiating the unlocking of the locking compartment for the purchased product (task 621). Briefly, these alternate tasks may be performed in lieu of the code comparison scheme described above.

As shown in FIG. 8, in response to the initiating of the unlocking procedure, inventory control process 600 may generate a suitably configured unlock signal (task 628). In the example embodiment, the unlock signal is generated by the server-based remote inventory control application in a format that facilitates transmission via the Internet 208. Accordingly, business entity server(s) 228 initiates the transmission of the unlock signal to local inventory control system 204 (task 630). As described above, communication module 508 (see FIG. 5) may perform task 630. Assuming that local inventory control system 204 has received the unlock signal, process 600 may initiate a timer or any suitable delay mechanism such that the unlock signal does not immediately cause the locking compartment to become unlocked. This feature is desirable to give the user/purchaser some time before having to actually remove the purchased product from local inventory control system 204. This feature may be particularly desirable in deployments where the user/purchaser initiates the e-commerce transaction at a different location than local inventory control system 204.

If the optional timer has timed out (query task 632), then local inventory control system 204 may initiate the conversion of the received unlock signal into a suitable actuator control signal (task 634). In the example embodiment, control signal converter 416 (see FIG. 4) performs this conversion. As described above, an IP-based unlock signal may not have electromagnetic properties sufficient to actuate the physical locking mechanisms employed by local inventory control system 204. Consequently, task 634 converts the unlock signal into an actuator control signal that is able to control the operation of the locking mechanism. Following task 634, inventory control process 600 may proceed to task 621 to initiate the electronic unlocking of the appropriate compartment.

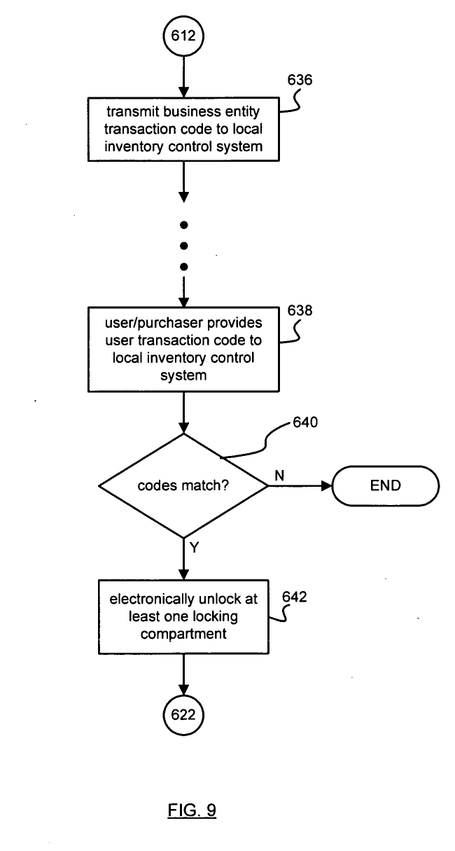

FIG. 9 depicts another alternate section of inventory control process 600, which may be employed by yet another practical embodiment of the invention. As depicted in FIG. 9, the alternate tasks may begin following the transmission of the user transaction code to the user/purchaser (task 612) and may end with the dispensing or removal of the purchased product (task 622). Briefly, these alternate tasks may be performed in lieu of the code comparison scheme described above.

As shown in FIG. 9, inventory control process 600 may transmit the business entity transaction code to local inventory control system 204 via the Internet 208 (task 636). In practice, local inventory control system 204 stores the received business entity transaction code for subsequent processing. Local inventory control system 204 may be configured to maintain the business entity transaction code for any specified period of time. In practice, as an added security measure the business entity transaction code and/or the user transaction code may have a limited lifespan. Assuming that the user/purchaser has successfully received the user transaction code, he or she can then enter or otherwise provide the user transaction code to local inventory control system 204 (task 638). The ellipses in FIG. 8 represent a possible time delay between the time that the codes are transmitted to the time that the user/purchaser actually decides to obtain the purchased product. In this regard, local inventory control system 204 can keep the product secured until the user/purchaser decides to pick up the product. Once local inventory control system 204 receives the user transaction code, it can then process the received user transaction code to determine its validity. In practice, local inventory control system 204 may compare the received user transaction code to one or more stored business entity transaction codes (query task 640). Alternatively, local inventory control system 204 may perform a decryption, decoding, or any suitable algorithm to process the received user transaction code and/or one or more stored business entity transaction codes. If the user transaction code does not match or otherwise correspond to one of the stored business entity transaction codes, then inventory control process 600 may end, generate an error message, or prompt the user/purchaser to enter a different user transaction code.

If, however, query task 640 determines that the entered user transaction code matches or otherwise corresponds to one of the stored business entity transaction codes, then inventory control process 600 may proceed to electronically unlock at least one of the locking compartments, doors, or bins of local inventory control system 204 (task 642). As mentioned above, task 642 preferably causes local inventory control system 204 to generate a suitable actuator control signal for the identified locking components, to thereby unlock the purchased product. Following task 642, inventory control process 600 may proceed to task 622 to initiate the dispensing or removal of the purchased product while local inventory control system 204 is in an unlocked state.

In summary, the inventory control architecture and techniques described herein can be utilized to provide centralized remote control of a physically lockable product storage system maintained at a local customer site. The system enables the manufacturer, vendor, or reseller of the regulated product to initiate unlocking procedures in response to the completion of e-commerce purchases of the product, which may be initiated at customer terminals located at the local customer site. Systems, devices, and methods configured in accordance with example embodiments of the invention relate to:

A method for controlling access to product inventory, the method comprising: providing an e-commerce application that facilitates online purchases of product stored in a local inventory control system; maintaining a remote inventory control application configured to regulate physical access to product stored in the local inventory control system; processing, with the e-commerce application, a transaction for purchasing product stored in the local inventory control system; and in response to the processing step, the remote inventory control application electronically initiating unlocking of at least a portion of the local inventory control system to provide access to purchased product. The e-commerce application can be realized in a business entity server system, and the local inventory control system can be located at a customer site. The remote inventory control application can be realized in a business entity server system, and the local inventory control system can be located at a customer site. The business entity server system may be located outside of the customer site, and the customer site may be a life sciences research laboratory. The e-commerce application may be used in a life sciences research laboratory supply program for managing vendor inventories. The method may further comprise: generating, with the remote inventory control application, an unlock signal; and transmitting the unlock signal to the local inventory control system to facilitate unlocking of the at least a portion of the local inventory control system. Transmitting the unlock signal may comprise routing the unlock signal through a packet network. Transmitting the unlock signal may comprise routing the unlock signal through the Internet. The method may further comprise converting the unlock signal into an actuator control signal configured to control a locking mechanism of the local inventory control system. The method may further comprise: generating, with the remote inventory control application, a business entity transaction code and a user transaction code corresponding to the business entity transaction code; and transmitting the user transaction code to a user to facilitate unlocking of the at least a portion of the local inventory control system. Transmitting the user transaction code may comprise sending an email containing the user transaction code to the user. The method may further comprise: the local inventory control system receiving the user transaction code; comparing the user transaction code to the business entity transaction code; and electronically unlocking the at least a portion of the local inventory control system if the user transaction code matches the business entity transaction code. The method may further comprise: transmitting the business entity transaction code to the local inventory control system; and the comparing step being performed by the local inventory control system. The method may further comprise unlocking the at least a portion of the inventory control system to provide access to a purchased life sciences research reagent product. The method may further comprise unlocking at least one compartment of a plurality of locking compartments of the local inventory control system. Each of the plurality of locking compartments may contain a different product, and product stored in the local inventory control system may be labeled with RFID tags. The method may further comprise performing an RFID interrogation to determine whether the purchased product is located within the local inventory control system. The remote inventory control application may provide access to only a limited amount of product stored in the local inventory control system.

A method for controlling access to product inventory, the method comprising: maintaining a server-based inventory control application configured to regulate physical access to product stored in a local inventory control system; processing an e-commerce transaction for purchased product stored in the local inventory control system; generating, with the server-based inventory control application, a business entity transaction code; receiving a user transaction code from a user of the local inventory control system; and the server-based inventory control application comparing the user transaction code to the business entity transaction code. The method may further comprise: generating, with the server-based inventory control application, the user transaction code; and transmitting the user transaction code to the user. Transmitting the user transaction code may comprise sending an email containing the user transaction code to the user. The method may further comprise electronically unlocking at least a portion of the inventory control system if the user transaction code matches the business entity transaction code. Electronically unlocking may comprise: generating, with the server-based inventory control application, an unlock signal; and transmitting the unlock signal to the local inventory control system to facilitate unlocking of the at least a portion of the local inventory control system. The method may further comprise unlocking the at least a portion of the inventory control system to provide access to a purchased life sciences research reagent product. The method may further comprise unlocking at least one compartment of a plurality of locking compartments of the local inventory control system. Each of the plurality of locking compartments may contain a different product. The server-based inventory control application may provide access to only a limited amount of product stored in the local inventory control system. Product stored in the local inventory control system may be labeled with RFID tags. The method may further comprise performing an RFID interrogation to determine whether the purchased product is located within the local inventory control system.

A method for obtaining access to product inventory, the method comprising: completing an e-commerce transaction for purchased product stored in a local inventory control system; receiving a user transaction code that facilitates electronic unlocking of at least a portion of the local inventory control system, the user transaction code being generated by a remote inventory control application; and entering the user transaction code into the local inventory control system to obtain access to the purchased product. The user transaction code may correspond to a business entity transaction code for the local inventory control system. In one embodiment, entering the user transaction code electronically unlocks the at least a portion of the local inventory control system if the user transaction code matches the business entity transaction code. In one embodiment, entering the user transaction code electronically unlocks at least one compartment of a plurality of locking compartments of the local inventory control system if the user transaction code matches the business entity transaction code. Each of the plurality of locking compartments may contain a different product. The method may further comprise removing the purchased product from the local inventory control system when the local inventory control system is in an unlocked state. The receiving step may comprise receiving the user transaction code through a packet network. The receiving step may comprise receiving an email containing the user transaction code. In one embodiment, entering the transaction code obtains access to a purchased life sciences research reagent product. Product stored in the local inventory control system may be labeled with RFID tags, and the method may further comprise performing an RFID interrogation to determine whether the purchased product is located within the local inventory control system. In one embodiment, entering the user transaction code obtains access to only a limited amount of product stored in the local inventory control system.

A method for storing and controlling access to product inventory, the method comprising: operating a local inventory control system; maintaining an e-commerce web site that facilitates online purchases of product stored in the local inventory control system; maintaining a remote inventory control application configured to regulate physical access to product stored in the local inventory control system; processing, with the e-commerce web site, a transaction for purchased product stored in the local inventory control system; and in response to the processing step, the remote inventory control application electronically initiating unlocking of at least a portion of the local inventory control system to provide access to the purchased product. The method may further comprise delivering replenishment product to the local inventory control system as a replacement for the purchased product. The method may further comprise: generating, with the remote inventory control application, a business entity transaction code and a user transaction code corresponding to the business entity transaction code; and transmitting the user transaction code to a user to facilitate unlocking of the at least a portion of the local inventory control system. The method may further comprise: the local inventory control system receiving the user transaction code; comparing the user transaction code to the business entity transaction code; and electronically unlocking the at least a portion of the local inventory control system if the user transaction code matches the business entity transaction code. In one embodiment, electronically unlocking comprises unlocking at least one compartment of a plurality of locking compartments of the local inventory control system. Each of the plurality of locking compartments may contain a different product. In one embodiment, transmitting the user transaction code comprises sending an email containing the user transaction code to the user. The method may further comprise unlocking the at least a portion of the inventory control system to provide access to a purchased life sciences research reagent product. Product stored in the local inventory control system may be labeled with RFID tags, and the method may further comprise performing an RFID interrogation to determine whether the purchased product is located within the local inventory control system. The remote inventory control application may provide access to only a limited amount of product stored in the local inventory control system.

An inventory control system comprising: a locking compartment configured to securely store product; a communication module configured to receive unlock signals, via a data communication network, from a remote inventory control application configured to regulate physical access to product stored in the locking compartment; and a locking mechanism coupled to the locking compartment and coupled to the communication module, the locking mechanism being configured to unlock the locking compartment in response to an unlock signal received by the communication module. The unlock signal may be generated by the remote inventory control application in response to an e-commerce transaction for purchased product stored in the locking compartment. In one embodiment, the product comprises life sciences research product. The inventory control system may further comprise a converter configured to convert unlock signals into respective actuator control signals, the actuator control signals being configured to control operation of the locking mechanism. The remote inventory control application may be realized in a business entity server system, and the inventory control system may be coupled to the business entity server system via the data communication network. The communication module may be Internet Protocol (“IP”) enabled, and the data communication network may be the Internet. The locking compartment may be one of a plurality of locking compartments of the inventory control system. Each of the plurality of locking compartments may contain a different product. In one embodiment, product stored in the inventory control system is labeled with RFID tags, and the inventory control system further comprises an RFID reader for performing an RFID interrogation to determine a location for product stored in the inventory control system. The remote inventory control application may provide access to only a limited amount of product stored in the inventory control system.

An inventory control system comprising: a locking compartment configured to securely store product; a communication module configured to receive business entity transaction codes, via a data communication network, from a remote inventory control application configured to regulate physical access to product stored in the locking compartment; a user interface configured to accept user transaction codes from a user; and a locking mechanism coupled to the locking compartment, the locking mechanism being configured to unlock the locking compartment if a user transaction code entered via the user interface matches a business entity transaction code received by the communication module. The business entity transaction codes may be generated by the remote inventory control application in response to e-commerce transactions for purchased product stored in the locking compartment. In one embodiment, the product comprises life sciences research product. The remote inventory control application may be realized in a business entity server system, and the inventory control system may be coupled to the business entity server system via the data communication network. In one embodiment, the communication module is Internet Protocol (“IP”) enabled and the data communication network is the Internet. The locking compartment may be one of a plurality of locking compartments of the inventory control system, and each of the plurality of locking compartments may contain a different product. In one embodiment, product stored in the inventory control system is labeled with RFID tags, and the inventory control system further comprises an RFID reader for performing an RFID interrogation to determine whether the purchased product is located within the local inventory control system. The remote inventory control application may provide access to only a limited amount of product stored in the local inventory control system.

A remote server-based inventory control system comprising: an e-commerce application that facilitates online purchases of product stored in a local inventory control system; and an inventory control application configured to regulate physical access to product stored in the local inventory control system, the e-commerce application being configured to process a transaction for purchased product stored in the local inventory control system, and the inventory control application being configured to electronically initiate unlocking of at least a portion of the local inventory control system in response to the transaction, to provide access to the purchased product. The inventory control application may be further configured to generate an unlock signal, and the system may further comprise a communication module configured to transmit the unlock signal to the local inventory control system via a data communication network, to facilitate unlocking of the at least a portion of the local inventory control system. In one embodiment, the communication module is Internet Protocol (“IP”) enabled, and the data communication network is the Internet. The inventory control application may be further configured to generate a business entity transaction code and a user transaction code corresponding to the business entity transaction code, and the system may further comprise a communication module configured to transmit the user transaction code to a user to facilitate unlocking of the at least a portion of the local inventory control system. In one embodiment, the communication module is Internet Protocol (“IP”) enabled, and the data communication network is the Internet. In one practical embodiment, the product may comprise life sciences research product. The inventory control application may be configured to electronically initiate unlocking of at least one compartment of a plurality of locking compartments of the local inventory control system. Each of the plurality of locking compartments may contain a different product. Product stored in the local inventory control system may be labeled with RFID tags, and the local inventory control system may be configured to perform an RFID interrogation to determine whether the purchased product is located within the local inventory control system. The inventory control application may provide access to only a limited amount of product stored in the local inventory control system.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for controlling access to product inventory, said method comprising:
providing an e-commerce application that facilitates online purchases of product stored in a local inventory control system;
maintaining a remote inventory control application configured to regulate physical access to product stored in said local inventory control system;
processing, with said e-commerce application, a transaction for purchasing product stored in said local inventory control system; and
in response to said processing step, said remote inventory control application electronically initiating unlocking of at least a portion of said local inventory control system to provide access to purchased product.

2. A method according to claim 1, said e-commerce application being realized in a business entity server system; and
said local inventory control system being located at a customer site.

3. A method according to claim 1, said remote inventory control application being realized in a business entity server system; and
said local inventory control system being located at a customer site.

4. A method according to claim 3, wherein the business entity server system is located outside of the customer site, and wherein the customer site is a life sciences research laboratory.

5. A method according to claim 4, the e-commerce application being used in a life sciences research laboratory supply program for managing vendor inventories.

6. A method according to claim 1, further comprising:
generating, with said remote inventory control application, an unlock signal; and
transmitting said unlock signal to said local inventory control system to facilitate unlocking of said at least a portion of said local inventory control system.

7. A method according to claim 6, further comprising converting said unlock signal into an actuator control signal configured to control a locking mechanism of said local inventory control system.

8. A method according to claim 1, further comprising unlocking said at least a portion of said inventory control system to provide access to a purchased life sciences research reagent product.

9. A method according to claim 1, further comprising unlocking at least one compartment of a plurality of locking compartments of said local inventory control system.

10. A method according to claim 9, wherein each of said plurality of locking compartments contains a different product.

11. A method according to claim 1, wherein product stored in said local inventory control system is labeled with RFID tags.

12. A method according to claim 11, further comprising performing an RFID interrogation to determine whether said purchased product is located within said local inventory control system.

13. A method according to claim 1, wherein said remote inventory control application provides access to only a limited amount of product stored in said local inventory control system.

14. A method for obtaining access to product inventory, said method comprising:
completing an e-commerce transaction for purchased product stored in a local inventory control system;
receiving a user transaction code that facilitates electronic unlocking of at least a portion of said local inventory control system, said user transaction code being generated by a remote inventory control application; and
entering said user transaction code into said local inventory control system to obtain access to said purchased product.

15. A method according to claim 14, said user transaction code corresponding to a business entity transaction code for said local inventory control system.

16. A method according to claim 15, wherein entering said user transaction code electronically unlocks said at least a portion of said local inventory control system if said user transaction code matches said business entity transaction code.

17. A method according to claim 16, wherein entering said user transaction code electronically unlocks at least one compartment of a plurality of locking compartments of said local inventory control system if said user transaction code matches said business entity transaction code.

18. A method according to claim 17, wherein each of said plurality of locking compartments contains a different product.

19. A method according to claim 14, further comprising removing said purchased product from said local inventory control system when said local inventory control system is in an unlocked state.

20. A method according to claim 14, wherein entering said transaction code obtains access to a purchased life sciences research reagent product.

21. A method according to claim 14, wherein product stored in said local inventory control system is labeled with RFID tags.

22. A method according to claim 21, further comprising performing an RFID interrogation to determine whether said purchased product is located within said local inventory control system.

23. A method according to claim 14, wherein entering said user transaction code obtains access to only a limited amount of product stored in said local inventory control system.
